(19) United States
(12) Patent Application Publication
(10) Pub. No.: US 2013/0046524 A1
(43) Pub. Date: Feb. 21, 2013

(54) METHOD FOR MODELING A RESERVOIR BASIN

(71) Applicants: Patrick Nduru Gathogo, Salt Lake City, UT (US); Ricardo Hartanto, Salt Lake City, UT (US); Robert Suarez-Rivera, Salt Lake City, UT (US)

(72) Inventors: Patrick Nduru Gathogo, Salt Lake City, UT (US); Ricardo Hartanto, Salt Lake City, UT (US); Robert Suarez-Rivera, Salt Lake City, UT (US)

(73) Assignee: SCHLUMBERGER TECHNOLOGY CORPORATION, Sugar Land, TX (US)

(21) Appl. No.: 13/515,442

(22) PCT Filed: Dec. 9, 2010
(86) PCT No.: PCT/IB2010/055703

§ 371 Date: Oct. 31, 2012

Related U.S. Application Data
(60) Provisional application No. 61/286,454, filed on Dec. 15, 2009.

(51) Int. Cl. G06G 7/48

(52) U.S. Cl. 703/6

(57) ABSTRACT

A methodology improves the modeling of a geologic region, such as a hydrocarbon-bearing basin. The methodology comprises processing data to create a heterogeneous earth model based on a variety of data on material properties across the geologic region. The heterogeneous earth model is employed in combination with a stratigraphic model in a manner which creates a high resolution geologic-stratigraphic model. The high resolution geologic-stratigraphic model is useful for improving the analysis of hydrocarbon-bearing basins and other geologic regions.

### CROSS-REFERENCE TO RELATED APPLICATION

The present application claims priority from U.S. Provisional Application 61/286,454, filed Dec. 15, 2009, which is incorporated herein by reference.

### BACKGROUND OF THE INVENTION

Stratigraphic hydrocarbon basin models have been used to gain a better understanding of characteristics of hydrocarbon basins. However, traditional stratigraphic modeling has been limited by the resolution of regional-scale measurements, e.g. resolution of seismic data. Traditional modeling attempts to overcome this limitation by using supplemental core-scale data and log data, but current processes lack sufficient definition of the fine-scale variability of material properties along the seismically defined stratigraphic units. The consequence is a lower resolution model and homogenization of material properties across regions which, in reality, are substantially heterogeneous. This type of model may have value for initial exploration, but the model lacks resolution for impacting field development, e.g. drilling, completion strategy, and production.

### BRIEF SUMMARY OF THE INVENTION

In general, the present invention provides a methodology for improved modeling of a geologic region, such as a hydrocarbon-bearing basin. The methodology comprises processing data to create a heterogeneous earth model based on a variety of data on material properties across the basin. The heterogeneous earth model is employed in combination with a stratigraphic model in a manner which creates a higher resolution geologic-stratigraphic model. The high resolution geologic-stratigraphic model is useful for improving the analysis of geologic regions, such as hydrocarbon bearing basins, in a manner which provides information for improved field development.

### BRIEF DESCRIPTION OF THE DRAWINGS

Certain embodiments of the invention will hereafter be described with reference to the accompanying drawings, wherein like reference numerals denote like elements, and:

FIG. 1 is a flowchart illustrating an example of a method for modeling a geologic region, such as a hydrocarbon bearing basin;

FIG. 2 is a schematic illustration of a processing system which may be used to create and run a high resolution stratigraphic model;

FIG. 3 is a flowchart illustrating a more detailed example of a method for modeling a geologic region;

FIG. 4 is a schematic illustration of data collected for processing;

FIG. 5 is a schematic illustration of data collected for assembly of an initial stratigraphic model based on log correlation;

FIG. 6 is schematic illustration representing a log correlation consistent with rock class definitions and core geology;

FIG. 7 is schematic illustration representing changes in thickness within the same unit or rock class;

FIG. 8 is a schematic illustration providing a map of rock units or classes based on heterogeneous rock analysis definitions and other data;

FIG. 9 is a schematic illustration of changes in thickness and the development of major patterns in the properties of rock units or classes to identify a geologic trend of major events;

FIG. 10 is a schematic illustration of patterns in unit or rock classes thickness between time intervals which indicate and map structural features;

FIG. 11 is a schematic illustration of a living model for a given geologic region, such as a hydrocarbon bearing basin; and

FIG. 12 is a schematic illustration of how the new high resolution geologic model described herein can help identify the transformation of depositional units in a basin to various rock types including favorable gas shale units.

### DETAILED DESCRIPTION OF THE INVENTION

In the following description numerous details are set forth to provide an understanding of the present invention. However, it will be understood by those of ordinary skill in the art that the present invention may be practiced without these details and that numerous variations or modifications from the described embodiments may be possible.

The present invention generally relates to a methodology of improved modeling with respect to geologic features. For example, the method of modeling may employ a high resolution geologic-stratigraphic model which is readily applicable to hydrocarbon-bearing basins. The improved modeling technique facilitates not only exploration of hydrocarbon-bearing formations and/or other geologic features but also facilitates field development which may include improved drilling, improved completion strategy, and improved production.

According to an embodiment of the present invention, a methodology is provided for constructing a high resolution geologic-stratigraphic model of a hydrocarbon-bearing basin which is consistent with vertical and lateral distribution of material properties measured independently. The model also is consistent with multi-scale assessments based on core, log, and seismic measurements. Results generated by the high resolution geologic-stratigraphic model provide a better understanding of the economic potential of the hydrocarbon-bearing basin as a whole. By defining the reservoir architecture with higher resolution as compared to conventional techniques, the high resolution geologic-stratigraphic model provides better geometrical constraints for geostatistical modeling. The high resolution geologic-stratigraphic model also provides better grid models for subsequent numerical analysis and better definition of the variability and distribution of the in-situ stress. The present model also provides a greater degree of confidence in predictions of unexplored regions of the hydrocarbon-bearing basin.

The methodology described herein substantially increases the resolution of existing stratigraphic geological modeling by combining with such modeling heterogeneous earth modeling used to map material properties across the hydrocarbon-bearing basin. Certain heterogeneous earth modeling techniques are described in Patent Application Publication US 2009/0319243-A1, which is incorporated herein by reference. The combination of the present invention provides a high resolution geologic-stratigraphic model able to define the reservoir architecture of the hydrocarbon-bearing basin at a resolution not previously possible.

Results from the high resolution geologic-stratigraphic model of the present invention provide a better understanding of the temporal development of the hydrocarbon-bearing basin. The results also provide increased information regarding movement of the depositional center; an improved understanding of development of faulting and resulting compartmentalization; and an improved understanding of the migration of fluids and fluid types (water and/or hydrocarbons). The high resolution model further defines constraints to the time and conditions for sediment lithification on each compartment in relation to the thermal maturation of the system. Consequently, inferences may be drawn as to the evolution of pore pressure and the resulting in-situ stress in the system.

The high resolution geologic-stratigraphic model of the present invention further provides a robust platform for propagating knowledge and measurements from known locations in the hydrocarbon-bearing basin (obtained from core, log, and seismic measurements) to unexplored regions. The model also provides a reference and geometrical constraints for statistical population of properties across the hydrocarbon-bearing basin. This enables development of higher confidence in predictions and improvements in constrained volumetric material property models, such as volumetric grid models for numerical simulators.

Efficient hydrocarbon-bearing basin/reservoir exploration and production depends on gaining an understanding of the distribution and magnitudes of reservoir properties, including mechanical properties, fluid flow, pore pressure, and stress. In many reservoirs, material properties change considerably, both laterally and vertically, across the hydrocarbon-bearing basin. The changes occur despite the simple (low resolution) primary stratigraphic overprint which results from the deposition process; and the changes also occur due to time-dependent processes of diagenesis, interactions with living organisms, and other post-depositional geochemical processes. The latter are most common in high surface area systems with fine to very fine size sediments and a composition of diverse mineralogic and organic mixtures, e.g. tight mudstones, inter-laminated sandstones, and carbonates. The fine-scale stratigraphic model described herein enhances an understanding of the reservoir and serves to map the time sequence and spatial distribution of the post-depositional changes. The high resolution stratigraphic model also aids in the development of an improved basin-scale model and supports improved understanding of the economic potential of a given hydrocarbon-bearing basin. As a result, use of the high resolution geologic-stratigraphic model provides a beneficial impact on engineering decisions regarding early exploration and basin-scale exploration, including development of completion strategies for efficient reservoir production and for maximizing hydrocarbon recovery.

Hydrocarbon-bearing basins, e.g. hydrocarbon reservoirs, develop in geologic time following multiple sequences of deposition and accumulation of sediments, followed in turn by locally varying compaction, cementation, chemical alteration, bioturbation, and interaction with organic matter. The result is considerable regional and local stratigraphic complexity. During hydrocarbon-bearing basin development, climatic changes (e.g. changes in sea level), tectonic episodes (e.g. tectonic episodes creating fragmentation of the basin), and other occurrences cause additional changes in the local and regional depositional system which leads to further geologic complexity and variability in material properties.

Understanding and predicting these changes in a given region are extremely important to facilitate hydrocarbon exploration. The fine-scale or higher resolution stratigraphic model provides a substantially improved understanding of these changes and enables prediction of further changes, capacities, and capabilities of a given subterranean region, e.g. a hydrocarbon-bearing basin. Efficient reservoir exploration and production depends on gaining a thorough understanding of the distribution and magnitudes of reservoir properties, such as porosity, permeability, hydrocarbon saturation, pore pressure, mechanical strength, and other properties. The high resolution geologic-stratigraphic model of the present invention provides this understanding and, because these properties may change considerably from region to region as well as laterally and vertically, the model may also be employed to enable prediction of these changes.

According to one embodiment, the high resolution geologic-stratigraphic model is developed by coupling more conventional methods with a methodology which comprises mapping heterogeneity in material properties across the hydrocarbon-bearing basin based on log-scale and seismic-scale measurements using heterogeneous rock analysis. Heterogeneous rock analysis of log responses is a method of analysis which delineates regions with similar and dissimilar bulk responses. Heterogeneous rock analysis also defines the number, thickness, and stacking patterns of characteristic rock classes/units with well-defined properties, the classes/units being the building blocks of the heterogeneous system. The analysis may involve evaluation of a variety of data which may include laboratory measurements on cores, log measurements for multiple wells across the hydrocarbon-bearing basin, and integration of these data sets to seismic data (or other regional-scale valuations). Completion of the analysis results in creation of a heterogeneous earth model which provides the lateral and vertical distribution of rock units (classes) across the hydrocarbon-bearing basin. Integrating the heterogeneous earth model data with core data and petrophysical log analysis further defines material properties for each of these rock units (classes) across the hydrocarbon-bearing basin.

Although the heterogeneous earth model does not explain the sources of material property heterogeneity, it provides an accurate record of its spatial distribution across the hydrocarbon-bearing basin. The heterogeneous earth model also provides evidence regarding large variability in material properties existing within apparently homogeneous stratigraphic units as defined from seismic data and standard log analysis. Thus, the heterogeneous earth model provides important information which enables development of the higher resolution stratigraphic model.

Combination of the heterogeneous earth model with an initial stratigraphic model enables creation of the higher resolution geologic-stratigraphic model which, in turn, provides a rationale for the measured variability in material properties. As a result, the higher resolution geologic-stratigraphic model is able to create a consistent relationship between the time development of the hydrocarbon-bearing basin, the resulting geologic/stratigraphic complexity, and the resulting material properties. The high resolution geologic-stratigraphic model is thus also able to provide: a better understanding of the basin; guidance for extrapolating properties measured at well locations; and prediction of properties in unexplored sections of the hydrocarbon-bearing basin.

Furthermore, the high resolution geologic-stratigraphic model provides relationships between geologic variability in texture and composition and between material properties to aid in anticipating the effect of these changes on reservoir and non-reservoir properties (e.g., presence of pore pressure compartments, presence of faults not visible at seismic resolution, and/or development of migration paths). The high resolution geologic-stratigraphic model also provides a better understanding of the depositional environment, chemical diagenesis, thermal alterations, and/or tectonic alterations, as well as their times of occurrence. The model better defines the timing of faults in generation of reservoir compartments in relation to organic maturation and timing for hydrocarbon generation. Results based on the high resolution modeling include an evaluation of the potential mobilization of fluids through these faults as well as their condition of cementation, e.g. mineral field, hydrocarbon coated.

By employing the high resolution geologic-stratigraphic model, better knowledge is obtained regarding the consistent integration of geologic time of basin development, changes in basin geometry, basin cementation, and the general directions of sediment accumulation. This knowledge enables better definition of the historical development of in-situ stress in the basin in both vertical and horizontal directions, resulting in an improved understanding of the current distribution of in-situ stress in a given hydrocarbon-bearing basin. The resulting information and knowledge derived from the model substantially improves evaluations of a variety of factors, including mechanical stability and completion design. The mechanical stability factors may include well construction and sanding potential, while the completion design factors include hydraulic fracturing assessment.

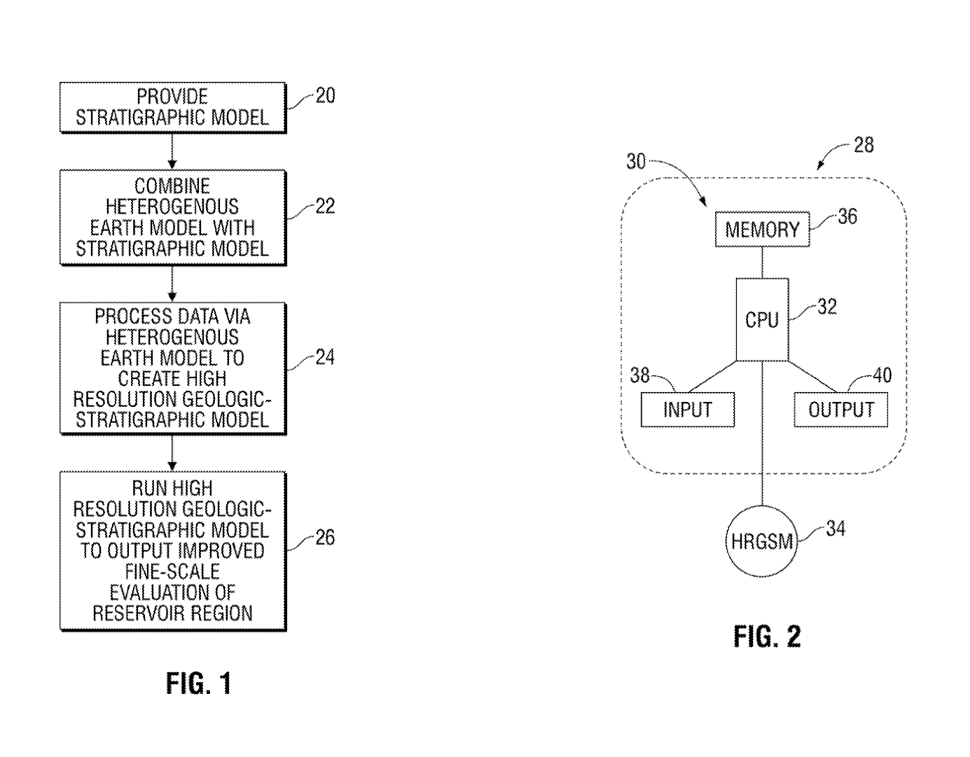

Referring generally to FIG. 1, a flowchart is provided to illustrate an embodiment of the methodology described herein for developing and utilizing the high resolution geologic-stratigraphic model. In this embodiment, a preliminary stratigraphic model is initially defined, as represented by block 20 in FIG. 1. The initial geologic-stratigraphic model is combined with a heterogeneous earth model which may be populated with numerous material properties related to the subterranean region (e.g. hydrocarbon-bearing basin) being evaluated, as represented by block 22. The data is processed via the heterogeneous earth model in combination with the initial stratigraphic model to create a high resolution geologic-stratigraphic model, as represented by block 24. The resultant high resolution geologic-stratigraphic model is run to analyze and output an improved, fine-scale evaluation of the reservoir region, as represented by block 26.

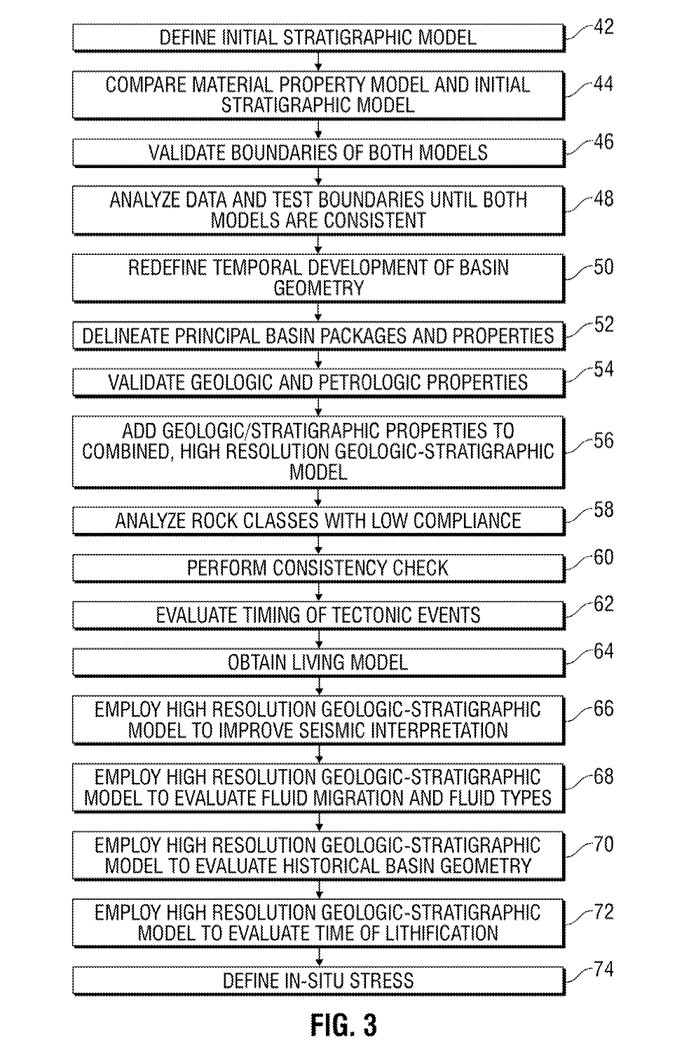

In this particular example, the various data may be input and the models constructed on a processor-based system 28, as illustrated schematically in FIG. 2. The processor-based system 28 may also be employed to run the high resolution geologic-stratigraphic model for evaluation of parameters related to the reservoir region. Some or all of the methodology outlined with reference to FIG. 1 and also with reference to FIGS. 3-11 (described below) may be carried out by processor-based system 28. In this example, processor-based system 28 comprises an automated system 30 designed to automatically perform fine-scale evaluations of data pursuant to the high resolution geologic-stratigraphic model.

The processor-based system 28 may be in the form of a computer-based system having a processor 32, such as a central processing unit (CPU). The processor 32 is operatively employed to intake data, process data, and run a high resolution geologic-stratigraphic model 34. The processor 32 may also be operatively coupled with a memory 36, an input device 38, and an output device 40. Input device 38 may comprise a variety of devices, such as a keyboard, mouse, voice recognition unit, touchscreen, other input devices, or combinations of such devices. Output device 40 may comprise a visual and/or audio output device, such as a computer display or monitor having a graphical user interface. Additionally, the processing may be done on a single device or multiple devices on location, away from the reservoir location, or with some devices located on location and other devices located remotely. Once the high resolution geologic-stratigraphic model 34 is constructed based on a combination of the initial stratigraphic model and the heterogeneous earth model, the resultant high resolution model may be stored on processor-based system 28 in, for example, memory 36.

In developing the high resolution geologic-stratigraphic model 34, numerous inputs related to the reservoir region, e.g. hydrocarbon bearing basin, are assembled. Some or all of this data is input to processor-based system 28 for construction of the desired model or models. For example, available core-scale data, including data from whole cores, sidewall cores, fragments, and drill cuttings, is input for evaluation. Additionally, available log-scale data, including standard and specialized logs, mud logs, and/or similar log data, is input to facilitate the modeling and evaluation. Similarly, available regional-scale data, including seismic data, gravity data, and electro-magnetic data, is also input to enhance the ultimate creation of a high resolution geologic-stratigraphic model.

Material properties, including mechanical properties, geochemical properties, and fluid flow properties, are used for populating the heterogeneous earth model. The material properties may be obtained via core log integration and/or specialized petrophysical analysis of logs and/or from a reservoir material properties database. Further inputs may comprise geologic and petrologic data and analyses, including core-geologic descriptions, borehole geologic analyses, core-based data of thin sections, and scanning electron microscopy and mineralogy, or equivalents to these data and analyses. The inputs to processor-based system 28 may also include integration of core-based data to log-scale. Available structural maps and structural reconstructions can also be used in model construction. Useful information may be input based on surface lineaments, topographic mapping, and records of tectonic activity, e.g. earthquakes, or volcanic activity. Furthermore, development of the heterogeneous earth model from the input data may be based on heterogeneous rock analysis and rock class tagging on multiple wells across the reservoir region, e.g. hydrocarbon bearing basin.

Referring generally to FIG. 3, a flowchart is provided to illustrate a more detailed example of development and use of the high resolution geologic-stratigraphic model 34. In this embodiment, a preliminary stratigraphic model is initially selected and defined for development into the high resolution geologic-stratigraphic model, as represented by block 42. The initial stratigraphic model is compared with a material property model, such as a heterogeneous earth model, as represented by block 44. The heterogeneous earth model may be of the type described in Patent Application Publication US 2009/0319243, or the heterogeneous earth model may be of other suitable types. In this example, the heterogeneous earth model is employed to overlay and compare boundaries of the rock units having unique material properties, i.e. rock classes, with stratigraphic boundaries identified in the initial stratigraphic model. The comparison is used to obtain a consistent model unifying the two concepts embodied in the material property model and the stratigraphic model, respectively.

The boundaries of both models are next validated, as represented by block 46. Effectively, the boundaries of the initial stratigraphic model and the rock class model (heterogeneous earth model) are validated, redefined, added, and/or altered in relation to consistent relationships between the evolving geologic process and the resulting distribution of material properties. The process increases the resolution of the initial stratigraphic model and tests the validity of the rock class model/heterogeneous earth model.

The data and test boundaries can be analyzed until the models are consistent with one another, as represented by block 48. If the rock class model and the stratigraphic model differ, geologic core description analysis may be employed to identify geologic markers and to verify/validate boundaries. This process is conducted iteratively and may employ analysis of data from multiple wells, including, for example, their core geology, petrologic images, and material properties. The iterative process further utilizes associated rock class definitions along with the analysis of data from the multiple wells to redefine the boundaries of the stratigraphic model (or in some instances the rock classes) until the descriptions are consistent with one another. Once the two models are consistent with one another, additional analysis is conducted as described below. Effectively, combination of the models to create the high resolution geologic-stratigraphic model enables the testing and validation of consistency between all measured properties across multiple scales.

For example, once consistency between the models is achieved, the temporal development of the hydrocarbon-bearing basin geometry is redefined, as represented by block 50. Redefining the temporal development comprises defining timelines based on the consistent heterogeneous earth model/rock class model and the stratigraphic model. Materials between two timelines represent events that happened within the same geologic time interval. Changes in thickness and depth location also help explain events, e.g. faulting, which cause changes in the geometry of the basin. The modeling further comprises a linear dating of the principal basin packages and their properties, as represented by block 52. Once the geometry of the principal basin packages coincides with the geometry defined by the building block material property units (rock classes), the latter model defines the material properties of the former model, including texture and composition. Effectively, the heterogeneous earth model includes material property definitions for each of the rock classes. If, as a result of the iterative process, new rock classes are defined and material properties for these rock classes are not available, additional appropriate sampling for laboratory testing and analysis may be used.

The creation and use of the high resolution geologic-stratigraphic model 34 further comprises the validation of geologic and petrologic properties between the stratigraphic model and the heterogeneous earth model, as represented by block 54. Material building block units, e.g. rock classes, may be determined and/or represented as having consistent geologic and petrologic properties. The consistent properties may include rock types, cement types, implied depositional environment, petrologic properties, e.g. depositional fabric, matrix composition, organic content, and other material properties.

Once the heterogeneous earth model and the stratigraphic model are combined through the iterative process, additional geologic/stratigraphic properties may be added to the combined model, as represented by block 56, to further develop the combined, high resolution geologic-stratigraphic model 34. For example, additional properties resulting from validation of the stratigraphic model may be added to the property definitions of the rock class model/heterogeneous earth model. Examples of these properties include geologic attributes, time of deposition, and/or consistent depositional environmental properties.

Part of the development of the high resolution geologic-stratigraphic model may also comprise analysis of rock class units which have low compliance to a reference rock class model, as represented by block 58. Depending on how the heterogeneous earth model was selected and constructed, rock classes with low compliance can exist in the combined model. The existence of rock classes with low compliance simply means that not all individual rock classes were identified in the reference model and newly identified units in the process are not compliant, i.e. have errors, in relation to those rock classes defined in the reference model. The degree of the error is an indication of how different these rock classes are relative to those in the reference model. The high resolution geologic-stratigraphic model 34 provides a rationale for these changes, and the model may be used to analyze the degree of consistency between these changes and the temporal evolution of the stratigraphic system.

Consistency is checked and verified between the geologic model and the heterogeneous rock model across the reservoir region, e.g. across the hydrocarbon bearing basin, as represented by block 60. The consistency check evaluation comprises a check on the consistency of the depositional environment, chemical diagenesis, maturation, tectonic events, and/or other occurrences. If consistency is not satisfied, the iterative process is resumed to redefine the temporal development of the basin geometry, as discussed above.

Based on the combined, high resolution geologic-stratigraphic model, an evaluation of the timing of compartmentalization of the basin, e.g. tectonic events, may be conducted, as represented by block 62. The evaluation is conducted based on the resulting fragmentation of the basin and on redistribution of the rock classes with similar properties. This allows faults to be defined which are not visible with seismic data. Consequently, any new information may be used to update the combined, high resolution geologic-stratigraphic model. The new information may also be used to update the consistency between the stratigraphic model components and the material property components of the heterogeneous earth model. The updating creates a living model, as represented by block 64, which may be updated every time additional data or additional observations are obtained.

Upon satisfactory development of the high resolution geologic-stratigraphic model 34, the model may be employed in a variety of ways to provide improved knowledge of the subject reservoir region with a much finer scale than with conventional models. For example, the high resolution geologic-stratigraphic model may be employed to improve seismic interpretation, as represented by block 66. Use of the consolidated stratigraphic/rock class model enables determination and evaluation of features not otherwise detected by seismic models, including faults in the reservoir region not previously resolved by the analysis of data.

The high resolution geologic-stratigraphic model may also be employed to evaluate fluid migration and fluid types, as represented by block 68. For example, the combined model may be employed to evaluate the timing/sequence of faults in relation to the known timeline of other events (e.g. thermal maturation, cementation) to define possible types of fluids which are capable of passing through these fractures. For example, the fractures may be laden with mineral fill or with hydrocarbon fill. The combined model provides higher resolution with respect to defining consistent temporal events of fluid migration and fluid types, including the development of regions with potential overpressure.

Additionally, the high resolution geologic-stratigraphic model may be employed to evaluate historical basin geometry, as represented by block 70. For example, the combined model is better able to evaluate a temporal movement and displacement of depositional centers. The results from such analysis help interpret changes in horizontal stresses and changes in the development of pore pressure variability from rock class to rock class of the hydrocarbon-bearing basin.

The combined, high resolution geologic-stratigraphic model also provides increased resolution for evaluating the time of lithification during movement and displacement of the depositional center in the basin, as represented by block 72. This high resolution analysis allows much improved definition of in-situ stress through the hydrocarbon-bearing basin, as represented by block 74. For example, the model facilitates analysis to define the orientation and magnitude of the changing in-situ stress during the evolution of the basin. The results of this analysis provide an improved understanding of the basin stress and pore pressure history which further improves the evaluation of the present in-situ stresses.

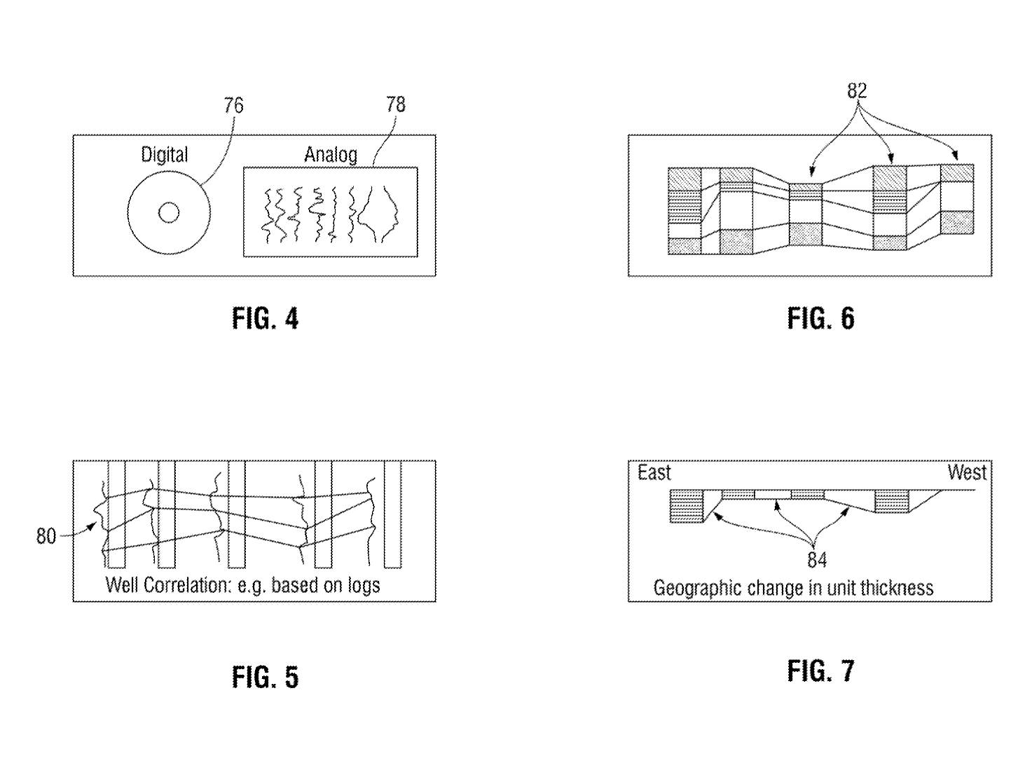

Development of the high resolution geologic-stratigraphic model and use of the model to improve evaluation of the geologic region, e.g. hydrocarbon-bearing basin, may be performed on processor-based system 28. As illustrated in FIG. 4, the initial data discussed above is collected and input to processor-based system 28 and may include information in a digital format 76 and/or an analog format 78. The data may be input via input device 38, via sensors, via stored information, or via other suitable sources. The data allows assembly of the initial stratigraphic model based on well correlations 80, such as log correlations, as illustrated in FIG. 5.

The processor-based system 28 is programmed to verify correlations between the initial stratigraphic model and the cluster model and/or core geologic description provided by the heterogeneous earth model. As illustrated in FIG. 6, the data is processed for individual rock classes or units 82 which are verified and, if necessary, redefined along with the initial stratigraphic model. For example, determinations are made to verify the initial log correlation is consistent with rock class definitions and core geology. If the consistency is not present, the necessary modifications are made on well correlation.

Subsequently, the processor-based system 28 is employed to reconstruct basin geometry/bathymetry for each time interval based on change in thicknesses between wells. As illustrated in FIG. 7, changes in geographic unit/rock class thickness 84 are illustrated. Changes in thickness within the same unit or rock class may indicate regional subsidence in the basin, or the changes may represent local tectonics. The processor-based system 28 is able to make determinations by comparing adjacent time intervals.

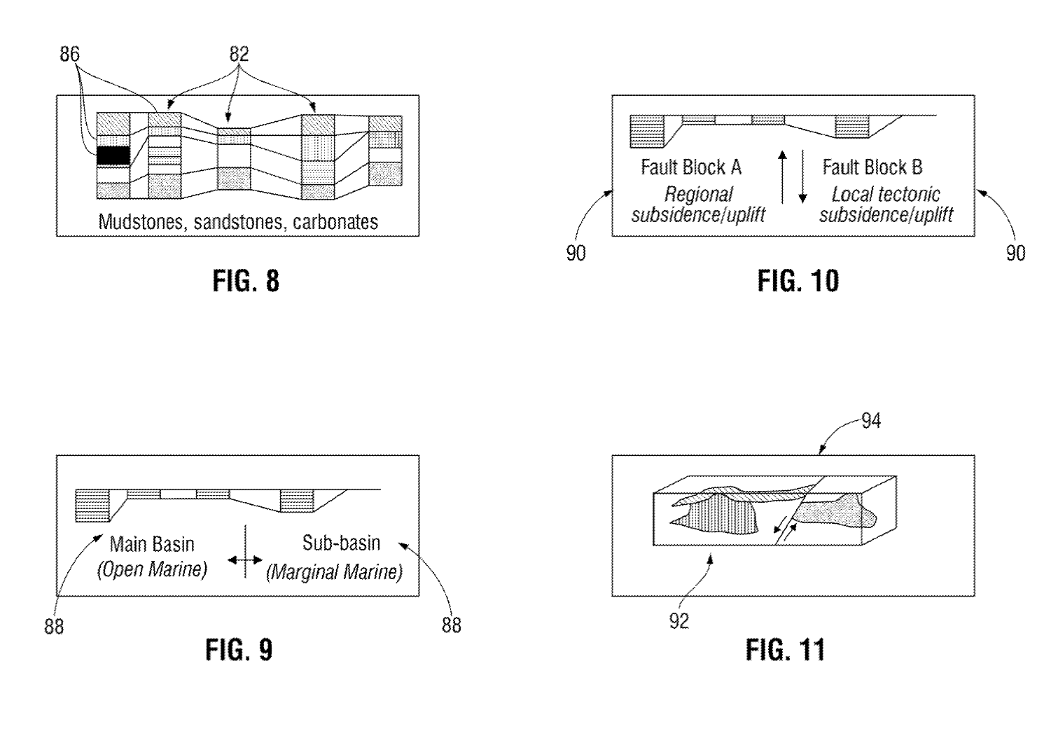

As illustrated in FIG. 8, processor-based system 28 may also be programmed to map rock units/rock classes based on heterogeneous rock analysis definitions, petrology, mineralogy, geochemistry, and other factors, as represented by the shading 86 of individual rock classes 82. Additionally, geologic trends of major events may be automatically identified. For example, sources of sediments and organic material, depositional energy, diagenesis, faulting, and other geologic trends may be identified and output to provide additional information on regions 88 of the basin, as illustrated in FIG. 9. With respect to the high resolution geologic-stratigraphic model 34, major patterns in the properties of rock units/rock classes should match with main trends in geologic events. If the patterns do not match, the iterative process can again be employed by adding more data to improve the consistency between the stratigraphic model and the rock class model/heterogeneous earth model.

Upon processing of the data and upon sufficient iterations to achieve consistency, a variety of structural features 90 of the basin may be mapped, as illustrated in FIG. 10. For example, the mapping of structural features may include mapping of faults identified using seismic data, structural maps, and other data. Patterns in unit/rock class thicknesses between time intervals indicate fault activity/reactivation. By way of further example, trends in cement diagenesis along faults may suggest fault permeability.

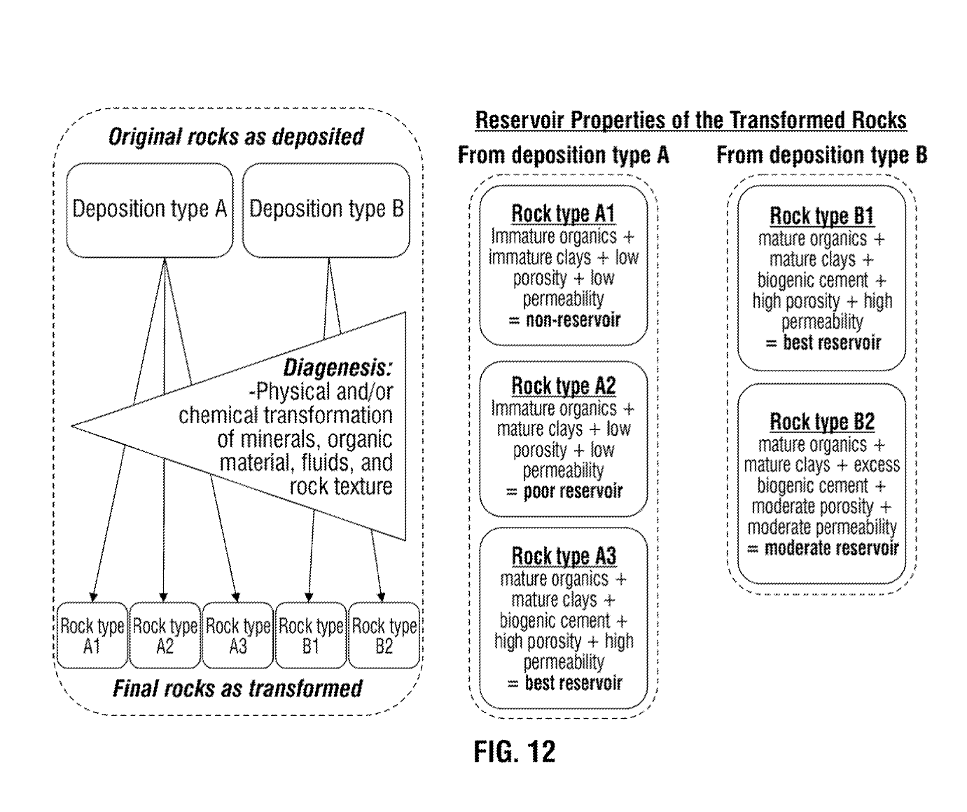

The processor-based system 28 may also be employed to provide predictions based on the data, including volumetric predictions and formation of a grid model for numerical applications. The data available and the resulting predictions may be updated with additional data to create a living model 92 of a reservoir region 94, e.g. hydrocarbon containing basin, as illustrated in FIG. 11. The high resolution geologic-stratigraphic model 34 may also be employed with other basin models and simulations to predict various events, including the timing of lithification, cement composition and crystallinity, kerogen form and microtexture, timing of faulting, and other events. For example, the model 34 may be employed to predict the nature (source type) and microtexture of kerogen material including its chemical and thermal transformations over time, as illustrated in FIG. 12. In FIG. 12, a schematic illustration is provided to show how the present methodology can be employed to separate deposition types which have undergone diagenesis into rock types. As illustrated on the right side of FIG. 12, the individual rock types have characteristics providing a relatively desirable or undesirable reservoir quality/desirability. The greater understanding provided by high resolution model 34 also enhances the prediction, and thus proposal for, migration paths for fluid flow as well as the distribution of regions with overpressure.

As described above, the present methodology provides an improved approach to modeling geologic features by integrating the heterogeneous rock analysis (rock classification) based on logs with the corresponding heterogeneous rock analysis (rock classification) based on seismic data. The analysis defines rock classes at log scale and at seismic scale. The two are integrated by lowering the resolution of the log responses to approximate the seismic resolution. The reduced resolution log driven rock classes are used to identify the corresponding rock classes based on pattern definition of the seismic attributes. The final model describes the large-scale, low resolution rock classes that are associated to smaller scale, high resolution rock class packages (with smaller variability within themselves), which in turn contain the statistical distribution of quantitative and semi-quantitative properties measured on cores, including petrographic, mineralogic, and geologic information. Also described are statistical distributions of geochemical, reservoir, and mechanical properties. The end result is a large-scale heterogeneous earth model with associated material properties across the region of interest.

The methodology effectively combines a stratigraphic model with a heterogeneous earth model to define a high resolution geologic-stratigraphic model which is consistent with the distribution of material properties measured independently and is also consistent with multi-scale assessment based on core, log, and seismic measurements. Combining the stratigraphic model with the heterogeneous earth model leads to a high resolution of the geologic-stratigraphic architecture and further provides better geometrical constraints for geo-statistical modeling. The resultant model also provides better guide models for subsequent numerical analysis and in-situ stress analysis. Additionally, the resultant model provides a greater degree of confidence in predictions related to unexplained regions of hydrocarbon-bearing basins.

Accordingly, the methodology described herein enables construction of a high-resolution geologic-stratigraphic model of a subterranean region, such as a hydrocarbon-bearing basin. The resultant, high resolution model is consistent with the vertical and lateral distribution of material properties, and the model is also consistent with multi-scale assessments based on core, log, and seismic measurements. The fine-scale results provide a substantially improved understanding of, for example, a given hydrocarbon-bearing basin and its economic potential. Definition of the reservoir architecture with the substantially higher resolution also enables the combined model to provide better geometrical constraints for geostatistical modeling (e.g. extrapolating properties from well to well), creation of better grid models for subsequent numerical analysis, and creation of better definitions regarding the variability and distribution of in-situ stresses. As a result, predictions of unexplored regions of the basin can be made with substantially higher confidence.

As discussed above, the high resolution geologic-stratigraphic model may be constructed in whole or in part on a processor-based system to automate the processing of data and the combination of the initial stratigraphic model with the rock class model/heterogeneous earth model. The processor-based system may also be used to run the resultant, high resolution geologic-stratigraphic model to evaluate a given basin and to output more accurate predictions regarding the basin. However, the initial stratigraphic model as well as the combined elements, e.g. heterogeneous earth model, may vary or be adjusted according to the particular environment or subterranean formation being evaluated. Additionally, the sequence of constructing and carrying out the combined model may be adjusted or changed to accommodate various parameters and considerations. For example, the development and analysis of rock classes may depend on the available data and/or the data which may be obtained for a given basin. Additionally, the process of iteration to obtain consistency between models may vary in type, length, and number of iterations depending on the specifics of the model selected and the data available.

Accordingly, although only a few embodiments of the present invention have been described in detail above, those of ordinary skill in the art will readily appreciate that many modifications are possible without materially departing from the teachings of this invention. Such modifications are intended to be included within the scope of this invention as defined in the claims.

What is claimed is:

1. A method of modeling a hydrocarbon-bearing basin, comprising:
defining and mapping variability in material properties across the hydrocarbon-bearing basin;
creating a heterogeneous earth model based on the defining and mapping of variability;
combining a stratigraphic model with the heterogeneous earth model to define a high resolution geologic-stratigraphic model that is consistent with the distribution of material properties measured independently and also is consistent with multi-scale assessments based on core, log, and seismic measurements; and
outputting results to a display medium to enhance understanding of the hydrocarbon-bearing basin.

2. The method as recited in claim 1, further comprising using the high resolution geologic-stratigraphic model to evaluate a temporal evolution of the hydrocarbon-bearing basin.

3. The method as recited in claim 1, further comprising using the high resolution geologic-stratigraphic model to evaluate time and mode of compartmentalization of the hydrocarbon-bearing basin.

4. The method as recited in claim 1, further comprising using the high resolution geologic-stratigraphic model to evaluate faulting and fracturing in the hydrocarbon-bearing basin.

5. The method as recited in claim 1, further comprising using the high resolution geologic-stratigraphic model to predict composition and microtexture of secondary minerals or cements and how they affect porosity, permeability, and lithification over time.

6. The method as recited in claim 1, further comprising using the high resolution geologic-stratigraphic model to predict the nature and microtexture of kerogen material including its chemical and thermal transformations over time.

7. The method as recited in claim 1, further comprising using the high resolution geologic-stratigraphic model to evaluate evolution of in-situ stress in the hydrocarbon-bearing basin.

8. The method as recited in claim 1, further comprising using the high resolution geologic-stratigraphic model to determine migration paths for fluid flow and the distribution of regions with overpressure in the hydrocarbon-bearing basin.

9. The method as recited in claim 1, further comprising using the high resolution geologic-stratigraphic model to provide a guide for geo-statistic modeling.

10. The method as recited in claim 1, further comprising using the high resolution geologic-stratigraphic model to provide a volumetric material property model for numerical simulation.

11. The method as recited in claim 1, further comprising using the high resolution geologic-stratigraphic model to provide a grid model for numerical simulation.

12. The method as recited in claim 1, further comprising using the high resolution geologic-stratigraphic model to test and validate consistency between measured properties across multiple scales.

13. A method for improving the modeling of a geologic basin, comprising:
inputting data from log-scale measurements and seismic-scale measurements to a processor-based system;
performing heterogeneous rock analysis of the data on the processor-based system; and
combining the heterogeneous rock analysis with a stratigraphic model to increase the resolution of the stratigraphic model for improved mapping of heterogeneity in material properties across the geologic basin.

14. The method as recited in claim 13, wherein performing heterogeneous rock analysis comprises analyzing log responses to delineate regions of the geologic basin with similar and dissimilar bulk log responses.

15. The method as recited in claim 13, wherein performing heterogeneous rock analysis comprises defining the number, thickness, and stacking patterns of characteristic rock classes.

16. The method as recited in claim 13, wherein performing heterogeneous rock analysis comprises creating a heterogeneous earth model providing lateral and vertical distribution of the heterogeneous rock across the geologic basin.

17. The method as recited in claim 13, further comprising outputting results to a display medium to enhance understanding of the geologic basin.

18. A method of modeling a hydrocarbon-bearing basin, comprising:
combining a stratigraphic model with a heterogeneous earth model on a computer processing system in a manner which leads to a higher resolution of the geologic-stratigraphic architecture and provides better geometrical constraints for geo-statistical modeling; and
outputting results to a display medium to enhance understanding of the hydrocarbon-bearing basin.

19. The method as recited in claim 18, wherein combining a stratigraphic model with a heterogeneous earth model comprises providing better guide models for subsequent numerical analysis and in-situ stress.

20. The method as recited in claim 18, wherein combining a stratigraphic model with a heterogeneous earth model results in providing a greater degree of confidence in predictions of unexplained regions of hydrocarbon-bearing basins.
